(19) United States
(12) Patent Application Publication
(10) Pub. No.: US 2003/0088777 A1
(43) Pub. Date: May 8, 2003

(54) Method and system for generating security access key value for radio frequency card

(76) Inventors: Sang-Duk Bae, Sungnam-Si (KR); Jin-Soo So, Seoul (KR)

Correspondence Address: CANTOR COLBURN, LLP, 55 GRIFFIN ROAD SOUTH, BLOOMFIELD, CT, 06002

(21) Appl. No.: 10/289,909

(22) Filed: Nov. 7, 2002

(30) Foreign Application Priority Data
Nov. 8, 2001 (KR) 2001-69423

(51) Int. Cl. H04L 9/00

(52) U.S. Cl. 713/181

(57) ABSTRACT

A method and system for generating a unique security access key value for a radio frequency (RF) card are provided so that different kinds of RF cards issued by different companies can be read using a single card terminal in order to collect charge for the use of the RF cards. The system includes a card issuing unit, which reads a chip serial number from an empty RF card, performs an operation on the chip serial number according to a predetermined algorithm to generate a security access key value, and encodes the security access key value into the empty RF card; an RF card, which is activated by a radio frequency radiated from a card terminal, and when the RF card receives the same security access key value as that it has from the card terminal, transmits information recorded in its memory area to the card terminal in order to pay charge for the use of the RF card; and a card terminal, which receives a chip serial number from an RF card activated by a radio frequency radiated from an antenna of the card terminal, performs an operation on the chip serial number according to the predetermined algorithm the same as that used by the card issuing unit so as to generate a security access key value, and accesses the memory area of the RF card using the generated security access key value in order to collect charge for the use of the RF card.

### BACKGROUND OF THE INVENTION

1. Field of the Invention

The present invention relates to radio frequency (RF) card multiple access technology for reading different kinds of RF cards issued by different companies using a single card terminal and collecting charge, and more particularly, to a method and system for enabling a card terminal to generate a unique security access key value for each RF card and access a memory area of the RF card using the generated unique security access key value, thereby enhancing the security of the RF card.

2. Description of the Related Art

An RF card has an integrated circuit (IC) chip and an antenna coil connected to the IC chip therewithin but does not include a battery. Accordingly, in order to drive the IC chip, power supply must be provided from the outside of the RF card.

Such an RF card contactlessly introduces an RF signal forwarded from an RF card terminal into its antenna coil to induce electric power, rectifies the induced electric power, and uses the rectified electric power as a power source for the IC chip. In addition, the IC chip of the RF card wirelessly transmits card information to and wirelessly receives card information from the RF card terminal through the antenna coil.

Authentication of an RF card is different depending on a card issuing company and is very important in terms of security. Authentication of an RF card is performed using a security access module (SAM). RF cards issued by different card issuing companies can be approved using different unique SAMs provided by the individual card issuing companies. Accordingly, to read different kinds of RF cards, authenticate the RF cards, and collect charge for the uses of the RF cards, it is necessary to install as many different SAMs and antennas as the number of card issuing companies.

Conventionally, in order to access different kinds of RF cards using a single RF card terminal, RF card access systems must be separately installed for different kinds of RF cards issued by different card issuing companies in a single RF card terminal. The RF card access system includes an antenna, which always radiates a radio frequency to activate an RF card within an effective distance and transmits information to and receives information from the IC chip of the activated RF card; an RF modulation/demodulation module, which demodulates RF-modulated card information received through the antenna, modulates information of a card terminal into RF, and transmits the modulated RF to the RF card; an SAM, which accesses the RF card when the card information demodulated by the RF modulation/demodulation module is authorized to approve the use of the RF card and collect charge for the use.

In order to overcome the problem of installation of an RF card terminal for multiple access, a technique of allowing a plurality of SAMs to commonly use a single antenna has been introduced. Such a multiple access terminal including a single antenna and a plurality of SAMs is disclosed in Korean Patent No. 270615. The multiple access terminal disclosed in Korean Patent No. 270615 includes an antenna, which transmits and receives RF signals in order to access a common memory area or unique memory area of a wireless information recording medium; a wireless core module (i.e., an RF modulation/demodulation module), which demodulates an RF signal received through the antenna to detect wireless information recording medium information (i.e., a baseband signal) read from the wireless information recording medium, modulates information to be recorded on the wireless information recording medium into an RF signal, and transmits the RF signal to the antenna; a plurality of wireless SAMs, each of which extracts a code number system and an identification number from the wireless information recording medium information which has been demodulated by the wireless core module, verifies whether the wireless information recording medium is authorized, and generates additional information when the wireless information recording medium is authorized; and a wireless multiple access control unit, which performs serial or parallel interface between the wireless core module and the plurality of wireless SAMs in order to transmit the wireless information recording medium information detected by the wireless core module to the plurality of wireless SAMs according to a predetermined information transmission method and transmits information generated from each of the plurality of wireless SAMs to the wireless core module, thereby controlling the operation of the wireless core module accessing the memory of the wireless information recording medium.

In addition, a wireless information recording medium multiple access method for accessing a wireless information recording medium having a memory area, which is divided into a common access area and a unique access area, using a single antenna and a wireless core module is disclosed in Korean Patent No. 270615. The wireless information recording medium multiple access method includes reading the common memory area of the wireless information recording medium when the wireless core module receives an RF signal through the antenna; transmitting the information read from the common memory area of the wireless information recording medium to a plurality of wireless SAMs according to a predetermined information transmission method; receiving the result of verifying a code number system, the result of verifying an identification number, and data and command information for memory access from one of the plurality of wireless SAMs; accessing the unique memory area of the wireless information recording medium using the data and command information and transmitting the result of the access back to the wireless SAM; and returning to the previous accessing operation when an additional command is received from the wireless SAM after transmitting the result of the access in order to perform the additional command and ending the operation for accessing the wireless information recording medium when the additional command is not received.

The invention disclosed in Korean Patent No. 270615 is based on a concept that the memory area of an RF card is divided into a common access area and a unique access area, so the invention cannot be applied to usual RF cards used currently, which do not include the common memory area and unique memory area.

### SUMMARY OF THE INVENTION

To solve the above-described problems, it is a feature of the present invention to provide a method and system for generating a security access key value for a radio frequency (RF) card in order to read different kinds of RF cards issued by different card issuing companies and collecting charge for the use of each RF card using a single card terminal.

It is another feature of the present invention to provide a method and system for generating a security access key value for an RF card, through which an RF card issued by a new card issuing company can be authenticated and processed just by adding a simple security access module (SAM) without modifying an existing card terminal.

It is still another feature of the present invention to provide a method and system for generating a security access key value for an RF card, which do not badly affect a SAM within a card terminal except for loss within the limit of the RF card even when the security access key value is revealed by, for example, hacking.

In order to achieve the above or other features of the present invention, there is provided a method of generating a security access key value for a RF card. The method includes generating a security access key value by performing an operation on a chip serial number transmitted from an empty RF card according to a predetermined algorithm and encoding the security access key value into the empty RF card, thereby issuing an RF card having the security access key value; activating the RF card approaching within an effective distance of an antenna of a card terminal and reading the chip serial number from the RF card as an activation acknowledgement signal; generating a security access key value by performing an operation on the read chip serial number according to the algorithm used when the RF card is issued; and trying to access a memory area of the RF card using the security access key value generated using the chip serial number read from the RF card, and when the access is allowed, collecting charge for the use of the RF card based on information stored in the memory area of the RF card.

There is also provided a system for generating a security access key value for a RF card. The system includes a card issuing unit, which reads a chip serial number from an empty RF card, performs an operation on the chip serial number according to a predetermined algorithm to generate a security access key value, and encodes the security access key value into the empty RF card; an RF card, which is activated by a radio frequency radiated from a card terminal, and when the RF card receives the same security access key value as that it has from the card terminal, transmits information recorded in its memory area to the card terminal in order to pay charge for the use of the RF card; and a card terminal, which receives a chip serial number from an RF card activated by a radio frequency radiated from an antenna of the card terminal, performs an operation on the chip serial number according to the predetermined algorithm the same as that used by the card issuing unit so as to generate a security access key value, and accesses the memory area of the RF card using the generated security access key value in order to collect charge for the use of the RF card.

### BRIEF DESCRIPTION OF THE DRAWINGS

The above features and advantages of the present invention will become more apparent by describing in detail preferred embodiments thereof with reference to the attached drawings in which:

FIG. 1 is a schematic block diagram of an entire system according to the present invention;

FIG. 2 is a block diagram of a card terminal including a security access module (SAM) for generating an access key value for a radio frequency (RF) card according to an embodiment of the present invention;

FIG. 3 is a block diagram of a card issuing unit according to the embodiment of the present invention;

FIG. 4 is a flowchart of a procedure for registering a security access key value in an RF card according to an embodiment of the present invention; and

FIG. 5 is a flowchart of a procedure for accessing an RF card using a card terminal according to the embodiment of the present invention.

### DETAILED DESCRIPTION OF THE INVENTION

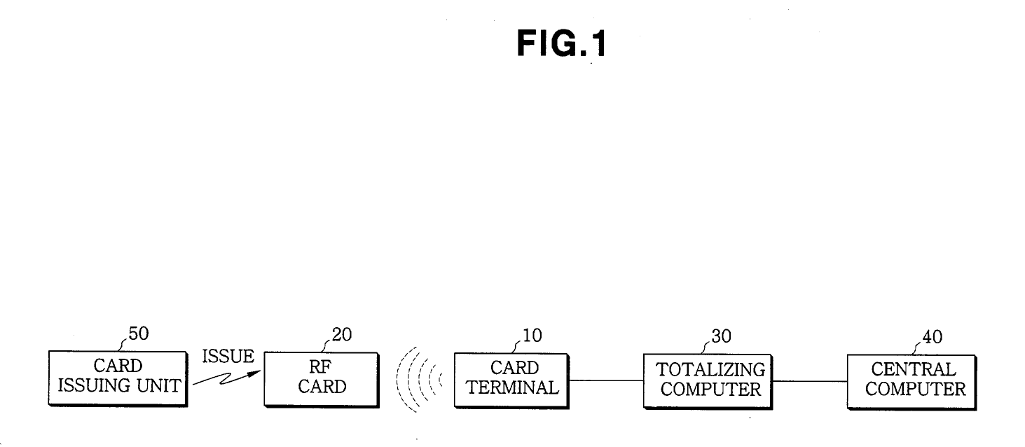

Referring to FIG. 1, a system according to the present invention includes a card terminal 10, a radio frequency (RF) card 20, and a card issuing unit 50. The card terminal 10 radiates a radio frequency through an antenna to activate an RF card approaching thereto, receives a chip serial number from the RF card, performs an arithmetic operation on the chip serial number according to a predetermined algorithm to generate a security access key value, and accesses the memory area of the RF card using the generated security access key value in order to collect charge for the use of the RF card. The RF card 20 is activated by the radio frequency radiated from the card terminal 10 and transmits information recoded in its memory area to the card terminal 10 when the same security access key value as that registered in the RF card is received from the card terminal 10 in order to pay charge for the use. The card issuing unit 50 reads a chip serial number from an empty RF card, performs an arithmetic operation on the chip serial number using a predetermined algorithm to generate a unique security access key value for the RF card, and encodes (or registers) the generated security access key value into the RF card.

The card terminal 10 is connected to a totalizing computer 30, which collects and processes charge collection information from at least one card terminal 10. The totalizing computer 30 is connected to a central computer 40, which provides black list (B/L) information necessary for giving an approval of a transaction of the RF card 20 to the card terminal 10.

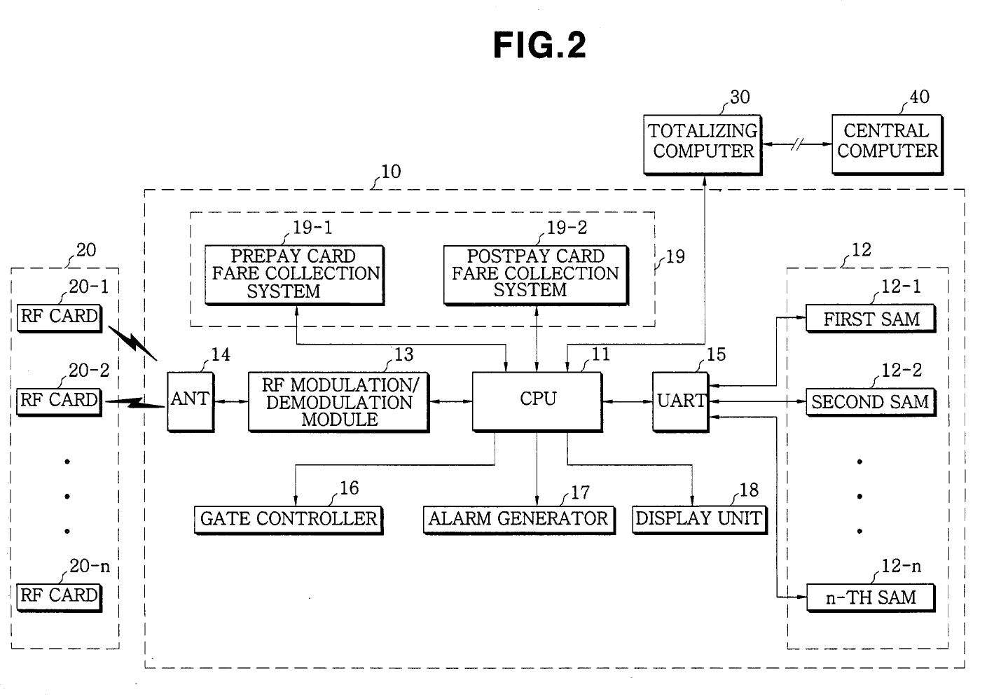

FIG. 2 is a detailed block diagram of the card terminal 10. Referring to FIG. 2, the card terminal 10 includes an antenna 14, RF modulation/demodulation module 13, a central processing unit (CPU) 11, a security access module (SAM) unit 12, and a universal asynchronous receiver and transmitter (UART) 15. The antenna (ANT) 14 generates a radio frequency signal for activating the RF card 20 (one of various RF cards issued by different card issuing companies) and sequentially receives a chip serial number and card information from the RF card 20. The RF modulation/demodulation module 13 demodulates an RF signal received through the ANT 14 into digital information and modulates digital key value information received from the SAM 12 through the CPU 11 into an RF signal. When receiving the chip serial number from the RF card 20, the CPU 11 transmits the chip serial number to a first SAM 12-1 within the SAM unit 12 through the UART 15 so that the first SAM 12-1 performs an algorithm registered therein in advance on the chip serial number to generate a security access key value, and tries to access the memory area of the current RF card 20 using the generated security access key value. When the CPU 11 succeeds in accessing the memory area of the RF card 20, it reads card number information or balance information from the memory area and performs a routine for collecting a fare according to a settlement method for the RF card 20. On the other hand, when the CPU 11 fails in accessing the memory area of the RF card 20 using the security access key value generated by the first SAM 12-1, the CPU 11 transmits the chip serial number of the RF card 20 to a second SAM 12-2 through the UART 15 and tries to access the memory area of the RF card 20 through the same procedure as described above. The SAM unit 12 includes first through n-th SAMs 12-1 through 12-n for different card issuing companies. The same algorithms as those registered in key value generation modules included in the card issuing unit 50 are programmed in corresponding ones among the first through n-th SAMs 12-1 through 12-n, so each of the first through n-th SAMs 12-1 through 12-n receives the chip serial number from the current RF card 20 and generates a security access key value for the RF card 20. The UART 15 is connected between the SAM unit 12 and the CPU 11 and sequentially interfaces the CPU 11 to the first through n-th SAMs 12-1 through 12-n one to one according to the authorization of the CPU 11.

The RF card 20 may be one among various RF cards, for example, prepaid cards and postpay cards having different settlement methods, and contactless credit cards and debit cards issued by different card issuing companies.

In addition, an RF card terminal gate system for automatically collecting fares for using public transportations such as buses and subway can be constructed by combining a gate controller 16, an alarm generator 17, a display unit 18, and a fare collection system 19. The fare collection system 19 may include either a prepay card fare collection system 19-1 or a postpay card fare collection system 19-2 or may include both of them to be compatible with various RF cards.

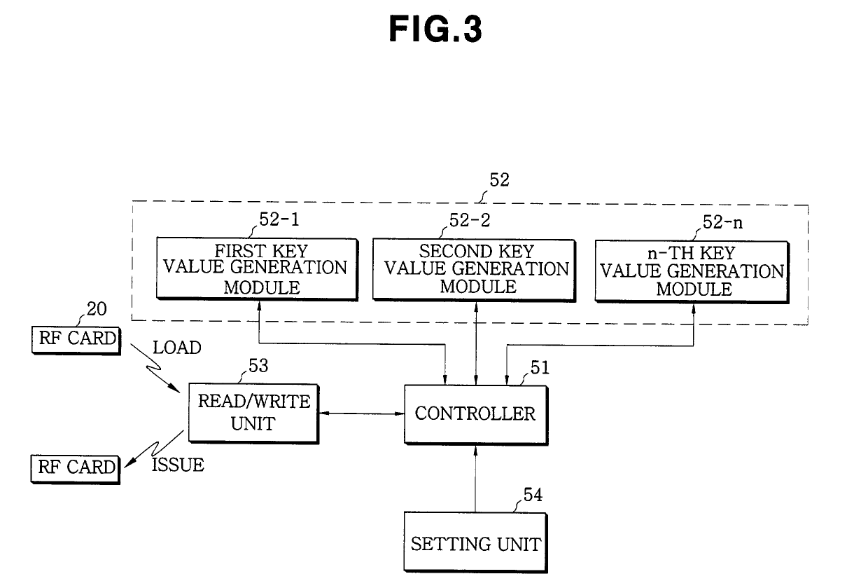

FIG. 3 is a block diagram of the card issuing unit 50. The card issuing unit 50 is provided to encode (register) a security access key value into an empty RF card. The card issuing unit 50 includes a read/write unit 53, a key value generation module 52, a controller 51, and a setting unit 54. The read/write unit 53 reads a chip serial number from an empty RF card and registers a security access key value generated from the key value generation module 52 into the empty RF card. The key value generation module 52 performs an operation on the chip serial number of the empty RF card according to a predetermined algorithm to generate a unique security access key value for each RF card. The controller 51 is connected between the key value generation module 52 and the read/write unit 53 in order to control their operations. The setting unit 54 sets and changes the algorithm of the key value generation module 52 and inputs control commands for the card issuing unit 50.

The operation of a security access key value generating system having the structure described above and a method thereof according to the present invention will be described.

If an empty RF card is loaded on the read/write unit 53 of the card issuing unit 50 in order to encode a security access key value into the empty RF card, the read/write unit 53 reads a chip serial number from the empty RF card and transmits it to the key value generation module 52 through the controller 51.

The key value generation module 52 performs an operation on the chip serial number of the empty RF card using a predetermined arithmetic program to generate a security access key value. For example, if the chip serial number represented by SN is 12345678 and an algorithm is (SN×3)+126÷250, the security access key value is 3703716. Here, a simple algorithm using only numerals is exampled, but a complex algorithm using various characters and symbols can be used in order to enhance the security of RF cards.

The key value generation program, i.e., algorithm, used by the key value generation module 52 within the card issuing unit 50 are used by the SAM unit 12 within the card terminal 10 in order to verify the authorization of an RF card.

In particular, in order to enable a single card terminal to perform multiple access with respect to various RF cards, different algorithms for generating security access key values can be set in different key value generation modules, respectively, provided for different card issuing companies and/or different settlement methods (such as a prepay method, a postpay method, and a debit method), respectively so that a security access key value for each RF card is generated using a different algorithm depending on a card issuing company and/or a settlement method and is then encoded into the RF card to be issued. In this case, the card terminal needs to include a plurality of SAMs to generate security access key values according to the different algorithms. The same algorithms as those used by the key value generation modules are registered in the respective SAMs. Accordingly, an RF card multiple access terminal system, in which various RF cards can be authenticated and processed by a single card terminal, can be constructed.

A plurality of key value generation modules 52-1 through 52-n shown in FIG. 3 include unique algorithms for generating unique security access key values for individual RF cards according to a card issuing company and/or a settlement method in order to accomplish the above-described RF card multiple access. Here, the algorithms registered in the key value generation modules 52-1 through 52-n can be integrated into an operating program in the controller 51. In this case, unlike FIG. 3, the plurality of key value generation modules 52-1 through 52-n may not be diagrammatically shown.

Even if a plurality of key value generation programs for generating security access key values using chip serial numbers are installed in the controller 51, one key value generation program among them can be selectively executed through the setting unit 54 according to usual computing control technology.

As shown in FIG. 2, the card terminal 10 includes the plurality of SAMs 12-1 through 12-n in order to process all of various RF cards 20-1 through 20-n which are issued according to different algorithms depending on a card issuing company and/or a settlement method. In addition, the card terminal 10 is connected to the totalizing computer 30 and the central computer 40 so that fares collected from the RF card 20 can be totalized and adjusted.

The ANT 14 within the card terminal 10 radiates a radio frequency in order to activate the RF card 20 approaching within an effective distance (of about 10 cm when the RF card 20 is a transport card). For example, when the first RF card 20-1 is activated by a radio frequency radiated from the ANT 14, the first RF card 20-1 transmits its chip serial number to the ANT 14 of the card terminal 10. The chip serial number of the first RF card 20-1 received through the ANT 14 is demodulated by the RF modulation/demodulation module 13 into digital information and is then transmitted to the CPU 11. Then, the CPU 11 determines that the first RF card 20-1 has been approached, controls the UART 15 to transmit the chip serial number of the first RF card 20-1 to the first SAM 12-1 of the SAM unit 12.

The first SAM 12-1 applies the chip serial number of the first RF card 20-1 to its algorithm to generate a security access key value. The security access key value generated by the first SAM 12-1 is transmitted back to the first RF card 20-1 sequentially through the UART 15, the CPU 11, the RF modulation/demodulation module 13, and the ANT 14.

On receiving the security access key value from the card terminal 10, the first RF card 20-1 compares the received security access key value with its own security access key value, which was encoded and registered into the first RF card 20-1 by the card issuing unit 50. If both security access key values are the same, the first RF card 20-1 allows the card terminal 10 to access the memory area of the first RF card 20-1 so that the card terminal 10 collects charge for the use of the first RF card 20-1.

However, if the card terminal 10 is not allowed to access the memory area of the first RF card 20-1 using the security access key value generated by the first SAM 12-1, the CPU 11 transmits the chip serial number of the RF card 20-1 to the second SAM 12-2, so the second SAM 12-2 generate a security access key value by applying the chip serial number to its algorithm. The card terminal 10 tries to access the memory area of the first RF card 20-1 again using the security access key value generated by the second SAM 12-2.

As described above, the card terminal 10 sequentially generates security access key values using the SAMs 12-1 through 12-n and tries to access the first RF card 20-1 through the CPU 11 until the access is allowed. If the card terminal 10 cannot access the first RF card 20-1 using any of the security access key values from all of the SAMs 12-1 through 12-n included in the SAM unit 12, the card terminal 10 informs a user of the first RF card 20-1 that the first RF card 20-1 cannot be used through the alarm generator 17 and the display unit 18.

With such an operation, the card terminal 10 tries to access any RF cards 20-1 through 20-n approaching the ANT 14 and collects charge for the use of the RF cards 20-1 through 20-n using the fare collection system 19 when the access is allowed. The prepay card fare collection system 19-1 is used for prepay cards and the postpay card fare collection system 19-2 is used for postpay cards.

The collecting operation will be described below in detail.

If the card terminal 10 succeeds in accessing the memory area of the RF card 20 approaching thereto using a security access key value, which is generated based on the chip serial number of the RF card 20 by the SAM unit 12, the CPU 10 can recognize a settlement method of the RF card 20 from the settlement information of the RF card 20 or SAM information. The card terminal 10 reads balance information when the accessed RF card 20 uses a prepay method and a card number when the accessed RF card 20 uses a postpay or debit method, and collects charge for the use of the RF card 20 using the prepay card fare collection system 19-1 or the postpay card fare collection system 19-2 according to the recognized settlement method.

When the card terminal 10 is installed at a gate of a public transportation such as subway, the gate controller 16 connected to the CPU 11 selectively controls admission or rejection of a user's entrance according to whether a fare is normally collected from the RF card 20. In this case, the alarm generator 17 selectively operates according to the approval or rejection of fare transaction using the RF card 20, and the display unit 18 displays payment information, and balance information, etc., of the approved RF card 20.

The totalizing computer 30 receives and totalizes the fare collection information from the CPUs 11 of a plurality of card terminals 10 and transmits the totalized fare collection information to the central computer 40. Then, the central computer 40 settles accounts.

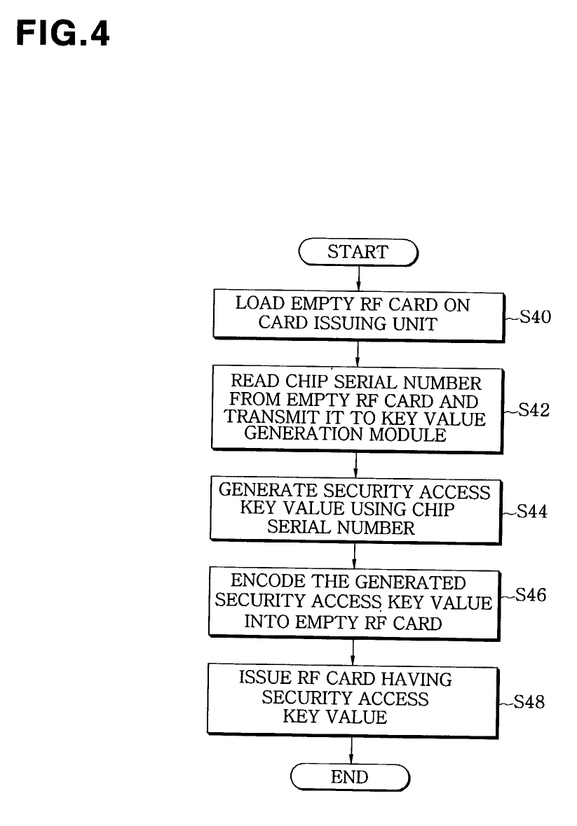

FIG. 4 is a flowchart of an encoding procedure performed on an empty RF card by the card issuing unit 50. Referring to FIG. 4, an empty RF card is loaded on the read/write unit 53 of the card issuing unit 50 in step S40. The chip serial number of the empty RF card is read by the read/write unit 53 and is then transmitted to the key value generation module 52 in step S42. Here, the empty RF card is activated by a radio frequency radiated from the read/write unit 53 to thus transmit its chip serial number to the read/write unit 53.

Then, the key value generation module 52 applies the chip serial number to a predetermined algorithm to generate a security access key value in step S44. The security access key value is transmitted to the read/write unit 53 and is then encoded and registered into the empty RF card in step S46. A normal RF card, which can be accessed by a card terminal, is issued in step S48. In order to perform encoding on an empty RF card, there may be provided the plurality of key value generation modules 52-1 through 52-n having unique algorithms different depending on a card issuing company and/or a settlement method. In this case, one key value generation module is selected from the plurality of key value generation modules 52-1 through 52-n, and a unique security access key value for the empty RF card is generated by applying the chip serial number of the empty RF card to the unique algorithm of the selected key value generation module and is then encoded into the empty RF card.

The selection of a key value generation module corresponding to a particular card issuing company and the different unique algorithms performed by the key value generation modules can be selectively set or changed using the setting unit 54 connected to the controller 51.

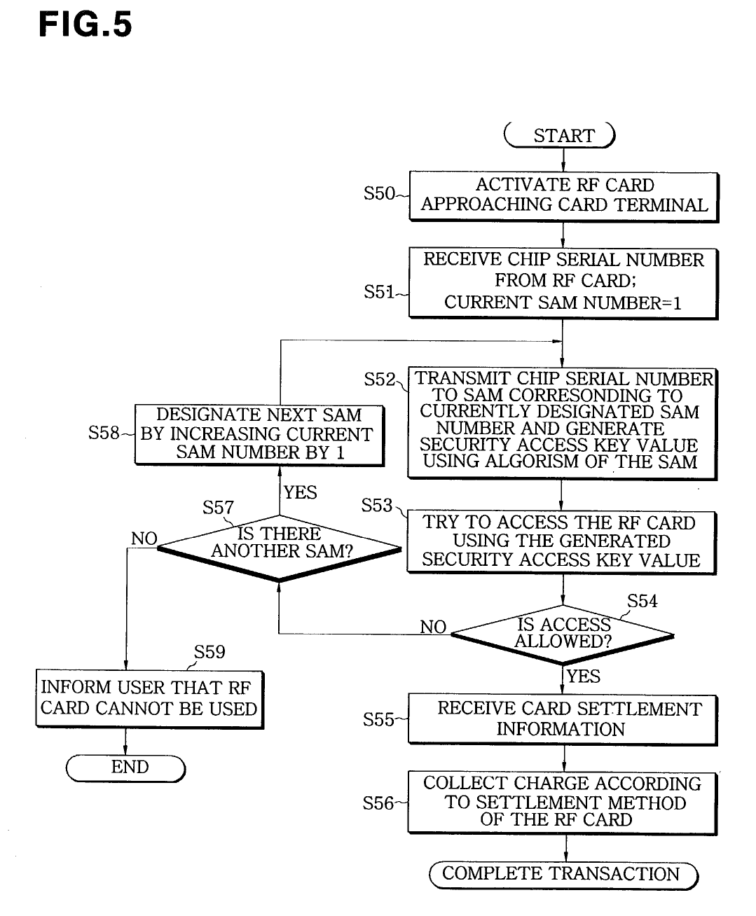

FIG. 5 is a flowchart of a procedure in which a card terminal accesses an RF card according to the embodiment of the present invention. Referring to FIG. 5, an RF card approaching within an effective distance (of about 10 cm when the RF card is a transport card) from an ANT of the card terminal is activated in step S50. The chip serial number is received from the RF card, and a current SAM number is designated as 1 in step S51. If the chip serial number is received by the CPU of the card terminal, the CPU transmits the chip serial number to the SAM having the currently designated SAM number through a UART to generate a security access key value according to an algorithm of the designated SAM in step S52. The card terminal tries to access the memory area of the RF card using the security access key value generated by the designated SAM in step S53.

If the access is allowed in step S54, the card terminal reads card settlement information from the memory area of the RF card in step S55 and collects charge for the use of the RF card using a fare collection system in step S56. If the access is not allowed in step S54, it is checked whether there is another SAM in step S57. If there is another SAM, the current SAM number is increased by 1 to designate the next SAM in step S58. Steps S52 through S54, S57, and S58 are repeated so that the chip serial number of the RF card is sequentially transmitted to second through n-th SAMs to generate security access key values and the card terminal tries to access the RF card using the security access key values generated by the second through n-th SAMs until the access is allowed. If there is no other SAM in step S57 in a state where the access to the RF card is not allowed, that is, if the access is not allowed using any one of the security access key values generated by all of the SAMs included in the card terminal, the card terminal informs a user of the RF card that the RF card cannot be used through an alarm generator and a display unit in step S59 and rejects RF card transaction.

As described above, according to the present invention, various RF cards issued by different card issuing companies can be authenticated, and charge for the use of the various RF cards can be collected, using a single card terminal.

In addition, an RF card issued by a new card issuing company can be authenticated and processed just by adding a simple SAM without modifying an existing card terminal.

Moreover, when the security access key value is revealed by, for example, hacking, a SAM within a card terminal is not badly affected although loss within the limit of the RF card occurs.

What is claimed is:

1. A system for generating a security access key value for a radio frequency (RF) card, the system comprising:
a card issuing unit, which reads a chip serial number from an empty RF card, performs an operation on the chip serial number according to a predetermined algorithm to generate a security access key value, and encodes the security access key value into the empty RF card;
an RF card, which is activated by a radio frequency radiated from a card terminal, and when the RF card receives the same security access key value as that it has from the card terminal, transmits information recorded in its memory area to the card terminal in order to pay charge for the use of the RF card; and
a card terminal, which receives a chip serial number from an RF card activated by a radio frequency radiated from an antenna of the card terminal, performs an operation on the chip serial number according to the predetermined algorithm the same as that used by the card issuing unit so as to generate a security access key value, and accesses the memory area of the RF card using the generated security access key value in order to collect charge for the use of the RF card.

2. The system of claim 1, wherein the card issuing unit comprises a read/write unit, a key value generation module, a controller, and a setting unit;
the read/write unit reads a chip serial number from an empty RF card and encodes a security access key value generated from the key value generation module into the empty RF card;
the key value generation module performs an operation on the chip serial number of the empty RF card according to a predetermined algorithm to generate a unique security access key value for the empty RF card;
the controller is connected between the key value generation module and the read/write unit in order to control their operations; and
the setting unit sets and changes the algorithm of the key value generation module and inputs control commands for the card issuing unit.

3. The system of claim 2, wherein the key value generation module comprises a plurality of first through n-th key value generation modules having unique algorithms for generating unique security access key values according to a card issuing company and/or a settlement method.

4. The system of claim 1, wherein the card terminal comprises an antenna, an RF modulation/demodulation module, a central processing unit (CPU), and a security access module (SAM) unit;
the antenna generates a radio frequency for activating the RF card and sequentially receives a chip serial number and card information from the RF card;
the RF modulation/demodulation module demodulates an RF signal received through the antenna into digital information and modulates digital key value information received from the SAM unit through the CPU into an RF signal;
the CPU receives the chip serial number from the RF card, transmits the chip serial number to the SAM unit so that the SAM unit performs an algorithm registered therein in advance on the chip serial number to generate a security access key value, tries to access the memory area of the current RF card using the generated security access key value, and if it succeeds in accessing the memory area of the RF card, reads card number information or balance information from the memory area and performs a routine for collecting a fare according to a settlement method of the RF card; and
the SAM unit receives the chip serial number from the current RF card and generates a security access key value for the RF card by applying the chip serial number to the algorithm registered therein.

5. The system of claim 4, wherein the SAM unit is realized as a multiple SAM comprising a plurality of first through n-th SAMs for multiple access to various RF cards, and the system further comprises a universal asynchronous receiver and transmitter (UART) between the CPU and the first through n-th SAMs in order to sequentially interface the CPU with the first through n-th SAMs one to one.

6. A method of generating a security access key value for a radio frequency (RF) card, the method comprising:
generating a security access key value by performing an operation on a chip serial number transmitted from an empty RF card according to a predetermined algorithm and encoding the security access key value into the empty RF card, thereby issuing an RF card having the security access key value;
activating the RF card approaching within an effective distance of an antenna of a card terminal and reading the chip serial number from the RF;
generating a security access key value by performing an operation on the read chip serial number according to the algorithm used when the RF card is issued; and
trying to access a memory area of the RF card using the security access key value generated using the chip serial number read from the RF card, and when the access is allowed, collecting charge for the use of the RF card based on information stored in the memory area of the RF card.

7. The method of claim 6, wherein the algorithm is different depending on a card issuing company and/or a settlement method.
